(19) United States
(12) Patent Application Publication
(10) Pub. No.: US 2011/0185134 A1
(43) Pub. Date: Jul. 28, 2011

(54) TEMPORARY STATE SERVICE PROTOCOL

(75) Inventors: JOHN HARTLEY TOEWS, SEATTLE, WA (US); JACOB RICHARD PITTS, REDMOND, WA (US)

(73) Assignee: MICROSOFT CORPORATION, REDMOND, WA (US)

(21) Appl. No.: 12/692,210

(22) Filed: Jan. 22, 2010

(51) Int. Cl. G06F 15/16; G06F 9/54; G06F 12/00

(52) U.S. Cl. 711/158; 709/203; 719/328; 711/E12.001

(57) ABSTRACT

A temporary state service protocol is utilized by clients to temporarily store and access data within a temporary data store between different requests. Each client associated with a web page can create data in the data store independently from other clients for the same web page. An Application Programming Interface (API) is used to manage and interact with the data in the data store. The procedures in temporary state service protocol allow clients to add, modify, retrieve, and delete data in the data store. The clients may also use the API to place and remove virtual locks on instances of the data.

### BACKGROUND

The HyperText Transport Protocol (HTTP) is a stateless protocol that is used to request and serve web resources, such as web pages, graphics, and the like over the Internet. Each request is serviced as it arrives from a client and after the request is processed the data relating to the request is discarded. As such, no state information is maintained across requests even from the same client. It is useful, however, to maintain information across requests for certain solutions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A temporary state service protocol is utilized by clients to temporarily store and access data within a data store between different requests made by end users Each client can create and manage one or more items for storing data in the data store independently from other clients. An Application Programming Interface (API) is used to create and interact with the data that is temporarily stored in items in the data store. The procedures associated with the temporary state service protocol are directed at allowing clients to add, modify, retrieve, and delete data in the data store. The clients may also use the API to place and remove virtual locks when accessing data as well as specify expiration times for the data stored within the items.

### BRIEF DESCRIPTION OF THE DRAWINGS

FIG. 1 illustrates an exemplary computing environment;

FIG. 2 shows a system having multiple clients that utilize a temporary service state protocol for independently managing and interacting with items temporarily stored in a data store; and

FIG. 3 shows an illustrative overview process for interacting with data that is stored temporarily in items in a data store.

### DETAILED DESCRIPTION

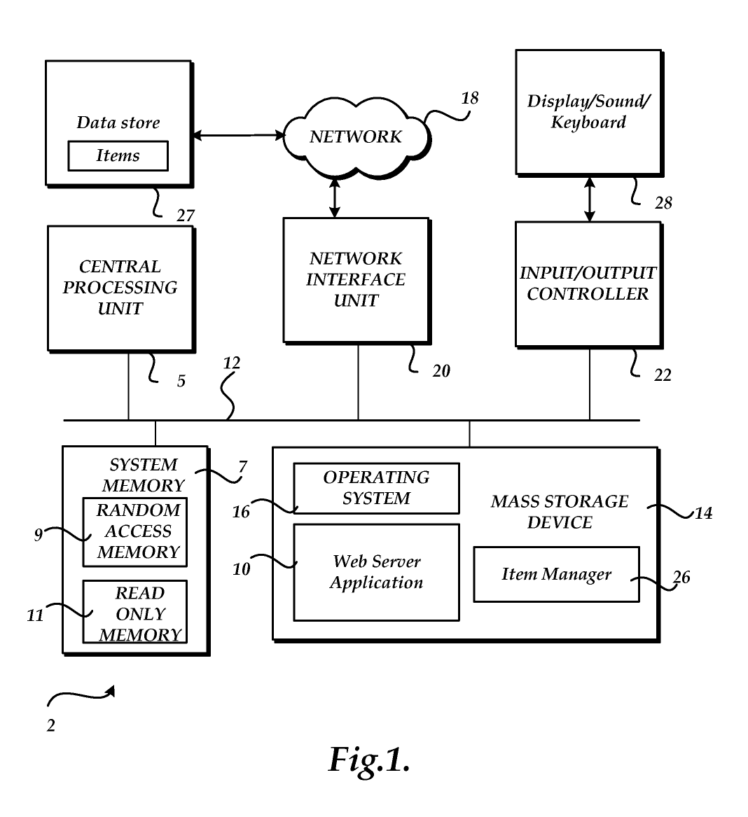

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an exemplary computer architecture for a computer 2 utilized in various embodiments will be described. The computer architecture shown in FIG. 1 may be configured in many different ways. For example, the computer may be configured as a web server, a personal computer, a mobile computer and the like. As shown, computer 2 includes a central processing unit 5 (“CPU”), a system memory 7, including a random access memory 9 (“RAM”) and a read-only memory (“ROM”) 11, and a system bus 12 that couples the memory to the CPU 5. A basic input/output system containing the basic routines that help to transfer information between elements within the computer, such as during startup, is stored in the ROM 11. The computer 2 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 2. Although the description of computer-readable media contained herein refers to a mass storage device, such as a hard disk or CD-ROM drive, the computer-readable media can be any available media that can be accessed by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments, the computer 2 operates in a networked environment using logical connections to remote computers through a network 18, such as the Internet. The computer 2 may connect to the network 18 through a network interface unit 20 connected to the bus 12. The network interface unit 20 may also be utilized to connect to other types of networks and remote computer systems.

The computer 2 may also include an input/output controller 22 for receiving and processing input from a number of devices, such as: a keyboard, mouse, electronic stylus and the like (28). Similarly, the input/output controller 22 may provide output to a display screen, a printer, or some other type of device (28).

As mentioned briefly above, a number of program modules and data files may be stored in the mass storage device 14 and RAM 9 of the computer 2, including an operating system 16 suitable for controlling the operation of a networked computer, such as: the WINDOWS 7®, WINDOWS SERVER®, WINDOWS SHAREPOINT SERVER®, operating systems from MICROSOFT CORPORATION; UNIX; LINUX and the like. The mass storage device 14 and RAM 9 may also store one or more program modules. In particular, the mass storage device 14 and the RAM 9 may store a web server application program 10. According to one embodiment, the web server application 10 is a content management application, such as MICROSOFT CORPORATION'S SHAREPOINT 2010®. The web server application program 10 is operative to provide functionality for receiving requests from clients and processing the requests.

Typically, web server application 10 receives a request from a end user's browser application on a client computing device. A WWW browser, such as Microsoft's INTERNET EXPLORER®, is a software browser application program that may be used in requesting the data. Upon receiving the request from the user via the browser on a separate computing device, the web server application 10 retrieves the desired data from the appropriate data server. Generally, a request occurs over HTTP and includes one or more identifiers (ID) for one or more clients. HTTP is a higher-level protocol than TCP/IP and is designed for the requirements of the Web and is used to carry requests from a browser to a Web server and to transport pages from Web servers back to the requesting browser or client. Item manager 26 is used to temporarily store data in a location, such as data store 27, between requests such that data needed by a client is not lost between requests. Data store 27 is configured to store data within items for a number of clients. According to one embodiment, each client manages its own items within data store 27 independently from the other clients.

Generally, item manager 26 uses a temporary state service protocol that provides an API to clients to create, store and interact with data that is temporarily stored within items in data store 27. Instead of each client that is associated with a web page having to share and store data within a single item for the web page, each client that is associated with the web page can store data in one or more different items in data store that are each maintained separately. For example, a first client can store data in a first item, whereas a second client that is associated with the same page can store data in a second item. Each client can create items that are uniquely identified for storing data. When the clients retrieve items from the data store, clients can optionally request that a virtual lock be placed on the item to ensure exclusive access for the requesting client. The procedures associated with the protocol are directed at enabling clients to create, add, modify, retrieve, and delete items in a data store, such as data store 27. According to one embodiment, procedures are directed at enabling clients to access items with virtual locks and to remove virtual locks from instances of the item. Generally, when a client intends to modify data in an item, the client requests exclusive access to the item by requesting a lock on the item. The client receives an indication, such as a lock cookie identifying that a virtual lock is placed on the item. Once a client has completed working with an item of the data, the client can store the updated item in the data store and release the virtual lock identified by the lock cookie, thereby allowing other clients to access the item. If no changes were made to an item of the data, clients can release the virtual lock without making any modifications to the item in the data store. In some instances, a virtual lock held on an item will be considered stale after a period of time. In these situations, a client can forcibly remove the virtual lock from the item and/or the lock can be automatically removed. According to one embodiment, items within the data store are set to expire after a predetermined amount of time. For example, clients may set the expiration time and/or some other authorized user may set the expiration time. Using the API, clients can modify the expiration time for an item of the data in the data store without modifying the data itself. Clients can also remove an item of the data or all items of expired data from the data store. Additional details regarding the operation of the item manager 26 and the temporary state service protocol will be provided below.

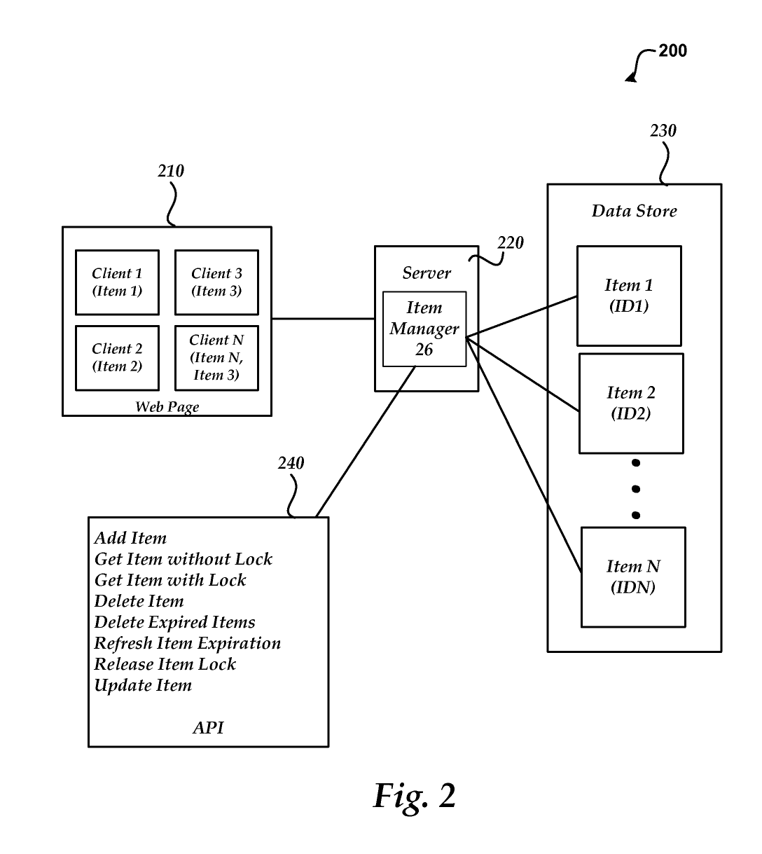

FIG. 2 shows a system having multiple clients that utilize a temporary service state protocol for managing and independently interacting with items temporarily stored in a data store. As illustrated, system 200 includes web page 210 that is associated with multiple clients, such as clients 1-N. Each of the clients illustrated stores data temporarily in data store 230 between requests made to server 220. As briefly discussed above, item manager 26 is configured to provide a way for each client to interact with data that it has stored within an item, such as one or more of the items 1-N. As illustrated, client 1 is associated with Item 1 having an identifier of ID1; client 2 is associated with Item 2 having an identifier of ID2; client 3 is associated with Item 3 having an identifier of ID3; and client N is associated with two items (Item N having an identifier of IDN and Item 1). Instead of each client receiving data that it is not interested in, each client utilizes API 240 to manage its own data that is to be temporarily stored. The procedures for API 240 that are associated with the temporary state service protocol are directed at allowing the clients to add items to the data store, modify data within the items, retrieve data from the items, and delete data from items in the data store. The clients may also use the API to place and remove virtual locks when accessing data within the items as well as modify expiration times of the items.

According to one embodiment, the procedures that are supported by API 240 include the following: an Add Item procedure; Get Item without Lock procedure; Get Item with Lock procedure; Delete Item procedure; Delete Expired Items procedure; Refresh Item Expiration procedure; Release Item Lock procedure; and an Update Item procedure.

The Add Item procedure is used by the clients to create a new item in data store 230 and insert data specified by the client calling the add item procedure into the item specified by the client into the data store.

The Get Item without Lock procedure retrieves data from the specified item in the data store without placing a virtual lock on the data. Placing a lock on an item in the data store prevents other clients from changing the data while the client that has placed the item in a lock interacts with the data. The Get Item without Lock procedure allows a client to view the data in the item but not modify the data.

The Get Item with Lock procedure retrieves data from the specified item the data store and attempts to place a virtual lock on the item for exclusive access by the requesting client. When the item is locked, only the client that placed the lock can modify the data.

The Delete Item procedure deletes an item of data from the data store.

The Delete Expired Items procedure deletes the expired items of data from the data store. According to one embodiment, an item expires after a predetermined period of time such that storage is not tied up for longer then needed within data store 230. The timeout can be set to many different values. For example, the expiration period may be ten minutes, thirty minutes, one hour, twenty four hours, and the like. According to one embodiment, each client determines an expiration time for each item that it has created. For instance, one client on web page 210 may need data in item 1 for fifteen minutes whereas another client, or the same client, on the web page may need data in another item for twenty four hours. According to one embodiment, calling the delete expired items procedure removes all of the expired items from the data store regardless of the client that created the item. The delete expired items procedure may be called by a client and/or automatically called at predetermined times.

The Refresh Item Expiration procedure updates the expiration time of an item of data in the data store. For example, a client may need to store the data longer then it first calculated. According to one embodiment, the refresh period is the same as a first indicated expiration time. According to another embodiment, the refresh period may be set to a different expiration time period.

The Release Item Lock procedure removes a virtual lock from an item of data such that other clients can access the item if needed.

The Update Item procedure updates an item of data in the data store.

The following are exemplary signatures of the procedures.

PROCEDURE AddItem (@id varchar(512), @item varbinary(max), @timeout int); where @id: The procedure associates the data in the data store with the supplied identifier. @id is not NULL. Data associated with the same @id does not already exist in the data store. @item: The data that is to be stored. The procedure does not place a virtual lock on the stored data. @timeout: A positive integer value in minutes indicating the time-out of the data. Return Values: An integer which is 0.

PROCEDURE GetItemWithoutLock (@id varchar(512), @item varbinary(max) OUTPUT, @locked bit OUTPUT, @lockAgeInSeconds int OUTPUT, @lockCookie int OUTPUT,); where @id: The procedure attempts to retrieve data associated with the supplied identifier. @item: The value passed into the procedure in this parameter is ignored. If no data exists for the identifier supplied in the @id variable, a NULL value is returned. If the data identified by the @id variable does not have a virtual lock on it, the procedure returns the data in the @item output parameter. Otherwise a NULL value is returned in the @item output parameter. @locked: The value passed into the procedure in this parameter is ignored. If no data exists for the identifier supplied in the @id variable, a NULL value is returned. If the data identified by the @id variable does not have a virtual lock on it, a 0 is returned in the @locked output parameter. Otherwise a 1 is returned in the @locked output parameter. @lockAgeInSeconds: The value passed into the procedure in this parameter is ignored. If no data exists for the identifier supplied in the @id variable, a NULL value is returned. If the data identified by the @id variable does not have a virtual lock on it, the value returned in the @lockAgeInSeconds output parameter is 0. Otherwise @lockAgeInSeconds is not NULL, and the procedure returns the lock age in seconds of the data in the @lockAgeInSeconds output parameter. @lockCookie: The value passed into the procedure in this parameter is ignored. If no data exists for the identifier supplied in the @id variable, a NULL value is returned. If the data identified by the @id variable does not have a virtual lock on it, the value returned in the @lockCookie output parameter is ignored by the protocol client. Otherwise, the procedure returns the lock cookie currently associated with the virtual lock in the @lockCookie output parameter which is not NULL. Return Values: An integer which is 0.

PROCEDURE GetItemWithLock (@id varchar(512), @item varbinary(max) OUTPUT, @locked bit OUTPUT, @lockAgeInSeconds int OUTPUT, @lockCookie int OUTPUT); where @id: the procedure attempts to retrieve data associated with the supplied identifier. @item: the value passed into the procedure in this parameter is ignored. If no data exists for the identifier supplied in the @id variable, a NULL value is returned. If the data identified by the @id variable does not have a virtual lock on it, the procedure returns the data in the @item output parameter. Otherwise a NULL value is returned in the @item output parameter. @locked: The value passed into the procedure in this parameter is ignored. If no data exists for the identifier supplied in the @id variable, a NULL value is returned. If the data identified by the @id variable does not have a virtual lock on it, the value 0 is returned in the @locked output parameter, and the procedure places a virtual lock on the data. Otherwise, the value 1 is returned in the @locked output parameter. @lockAgeInSeconds: The value passed into the procedure in this parameter is ignored. If no data exists for the identifier supplied in the @id variable, a NULL value is returned. If the data identified by the @id variable does not have a virtual lock on it, the value returned in the @lockAgeInSeconds output parameter is 0. Otherwise, the procedure returns the lock age in seconds of the data's virtual lock in the @lockAgeInSeconds output parameter which is not NULL. @lockCookie: The value passed into the procedure in this parameter is ignored. If no data exists for the identifier supplied in the @id variable, a NULL value is returned. Otherwise, the procedure returns the lock cookie associated with the virtual lock in the @lockCookie output parameter which is not NULL. Return Values: An integer which is 0.

PROCEDURE DeleteExpiredItems ( ) attempts to delete all of the expired items in the data store; Return Values: An integer which is 0.

PROCEDURE DeleteItem (@id varchar(512), @lockCookie int,); deletes a specified item within the data store where @id: The identifier of data to remove. @lockCookie: The lock cookie of the data to remove. Return Values: An integer which is 0.

PROCEDURE RefreshItemExpiration (@id varchar(512),); where @id: The procedure updates the expiration time of the data associated with the supplied identifier. If no data exists for the identifier supplied in the @id variable, the procedure does not make any changes. Return Values: An integer which is 0.

PROCEDURE ReleaseItemLock (@id varchar(512), @lockCookie int,); where @id: The procedure removes the virtual lock from the data associated with the supplied identifier. If no data exists for the identifier supplied in the @id variable, the procedure does not make any changes. @lockCookie: If the value supplied in this parameter matches the lock cookie currently associated with the instance of data, the procedure removes the virtual lock from the data, and it updates the expiration time of the data. Otherwise, the procedure does not remove the virtual lock and does update the expiration time. Return Values: An integer which is 0.

PROCEDURE UpdateItem (@id varchar(512), @item varbinary(max), @timeout int, @lockCookie int,); where @id: The procedure updates the data in the data store associated with the supplied identifier. If no data exists for the identifier supplied in the @id variable, the procedure does not make any changes. @item: The new data that is to be stored if the lock cookie supplied in the @lockCookie parameter matches the lock cookie currently associated with the instance of data. Additionally, the procedure does not remove the virtual lock from the data. @timeout: A value in minutes indicating the lifetime of the supplied data. If the lock cookie supplied in the @lockCookie parameter matches the lock cookie currently associated with the item of data, the procedure updates the expiration time associated with the instance of data. @lockCookie: The procedure updates the data in the data store if the lock cookie supplied in the @lockCookie parameter matches the lock cookie currently associated with the instance of data. If this parameter does not match the lock cookie currently associated with the instance of data, the procedure does not make any changes. Return Values: An integer which is 0.

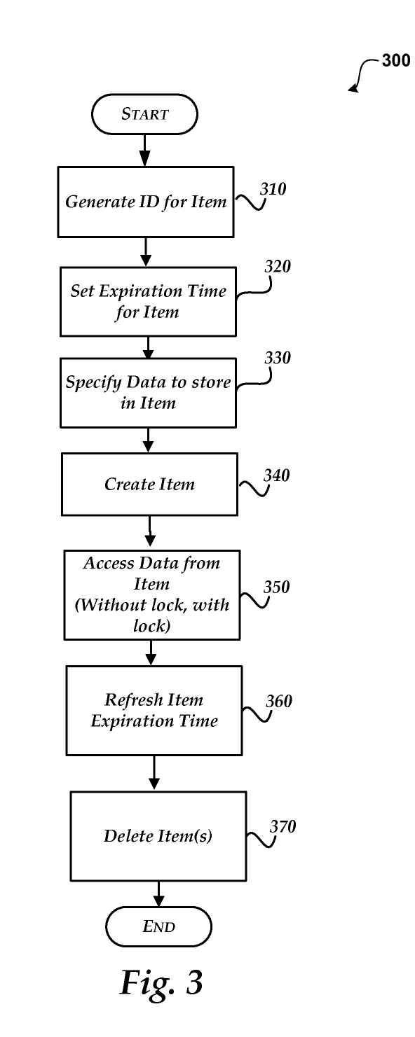

Referring now to FIG. 3 an illustrative process for using the temporary service state protocol will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

Referring now to FIG. 3, after a start operation, the process flows to operation 310, where an identifier for a new item to be created is determined. The identifier may be created by the client or on a different computing device. According to one embodiment, the client asks the API to generate the unique identifier for the item and uses the identifier when creating the item.

Moving to operation 320, an expiration time for the item is specified. The expiration time specifies a time period that is used to determine how long the item is to be maintained in the data store. According to one embodiment, the client creating the item specifies a timeout value from which the expiration time is calculated. Each item may have a different expiration time. For example, one item may expire after ten minutes whereas another item expires after two hours.

Moving to operation 330, an expiration time for the item is specified. The expiration time specifies a time period that is used to determine how long the item is to be maintained in the data store. According to one embodiment, the client creating the item specifies the value for the expiration time. Each item may have a different expiration time. For example, one item may expire after ten minutes whereas another item expires after two hours.

Transitioning to operation 340, the data specified by the client is stored in the data store. According to one embodiment, the data is stored within a database. The data, however, may be stored other ways. For example, the data may be stored in a file, separate files, and the like.

Moving to operation 350, a client requests to access the data. A client may read the data and/or update the data. According to one embodiment, a client may access the data with a lock such that the while the lock is in place, the client is the only client that is authorized to update the data within the item. The client may also access the data without a lock in which case the client is authorized to read the data but not make any updates to the data.

Flowing to operation 360, a client may refresh the expiration time of an item. For example, a client may want to store the data in the item for a longer period of time then was initially set.

Moving to operation 370, a client may use the API to delete a single item within the data store and/or delete every expired item within the data store. The process then moves to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for interacting with data stored temporarily between requests in a data store, comprising:
receiving a request at a server from a client associated with a web page relating to data that is temporarily stored within an item in a data store, wherein the web page comprises at least two different clients, wherein each client on the web page stores data temporarily within different items on the data store, and wherein each client manages data independently from the other clients using a temporary state service protocol;
processing the request; and
returning data to the client that relates only to the item requested by the client.

2. The method of claim 1, wherein the request is made by the client using an Application Programming Interface (API) that supports: an add item procedure that creates an item in the data store and inserts data in the item and associates the item with an identifier; a delete item procedure that deletes an item from the data store; and a get item procedure that retrieves data from the data store.

3. The method of claim 2, wherein the API further comprises a get item without lock procedure that retrieves data from an item in the data store without placing a virtual lock on the data, and a get item with lock procedure that retrieves data from an item in the data store and attempts to place a virtual lock on the data for exclusive access by the requesting client.

4. The method of claim 1, wherein the API further comprises a delete expired items procedure that deletes all expired items of data from the data store and a refresh item expiration that updates an expiration time of an item of the data in the data store.

5. The method of claim 4, wherein the API further comprises a release item lock that removes a virtual lock from an item of data.

6. The method of claim 1, wherein the API further supports an expired time parameter that specifies a time period for the item to reside on the data store.

7. The method of claim 6, wherein each client specifies the expired time parameter for the item.

8. The method of claim 7, wherein the API further comprises a refresh item expiration procedure that updates the expired time parameter associated with the item and a delete expired items procedure that attempts to remove each item within the data store that has expired.

9. The method of claim 2, wherein items within the data store are removed automatically after a period of time.

10. A computer-readable storage medium having computer-executable instructions for interacting with data stored temporarily between requests in a data store, comprising:
receiving a request at a server from a client associated with a web page relating to data that is temporarily stored within an item on a data store, wherein the web page comprises a client, wherein any client on the web page stores data temporarily within different items on the data store between requests to the server, and wherein each client associated with the web page manages data independently from the other clients using a temporary state service protocol and an associated an Application Programming Interface (API) that supports: an add item procedure that creates an item in the data store and inserts data in the item and associates the item with an identifier; a delete item procedure that deletes an item from the data store; and a get item procedure that retrieves data from the data store;
processing the request; and
returning data to the client that relates only to the item requested by the client.

11. The computer-readable storage medium of claim 10, wherein the add item procedure comprises parameters that specify the identifier for the item, the data that is to be stored in the data store after creation of the item and a timeout parameter that specifies a time period for the data to reside on the data store.

12. The computer-readable storage medium of claim 11, wherein the get item procedure comprises a get item without lock procedure that retrieves data from an item in the data store without placing a virtual lock on the data and comprises parameters that specify the identifier for the item and returns a lock age in parameter when the item has a lock, and a get item with lock procedure that retrieves data from an item in the data store and attempts to place a virtual lock on the data for exclusive access by the requesting client and comprises parameters that specify the identifier for the item.

13. The computer-readable storage medium of claim 10, wherein the delete expired item procedure deletes any expired items of data from the data store and comprises parameters that specify the identifier for the item and a refresh item expiration that updates an expiration time of an item of the data in the data store and comprises a parameter that specifies the identifier for the item.

14. The computer-readable storage medium of claim 13, wherein the API further comprises a release item lock that removes a virtual lock from an item of data and comprises parameters that specify the identifier for the item and a current lock for the item.

15. The computer-readable storage medium of claim 10, wherein the API further comprises an update item procedure that updates data within the item and comprises parameters that specify the identifier for the item, a parameter including the data for the item and a current lock for the item.

16. The computer-readable storage medium of claim 15, wherein each item within the data store is accessed and managed only by a single client.

17. A system for interacting with data stored temporarily between requests in a data store, comprising:
a network connection that is configured to connect to the IP network;
a processor and a computer-readable medium;
a data store for storing data temporarily within items;
an operating environment stored on the computer-readable medium and executing on the processor; and
an item manager operating under the control of the operating environment and operative to:
receive a request from a client associated with a web page relating to data that is temporarily stored within an item on the data store, wherein the web page comprises different clients, wherein each client on the web page stores data temporarily within different items on the data store between requests to the system, and wherein each client manages data independently from the other clients using a temporary state service protocol and an associated an Application Programming Interface (API) that supports: an add item procedure that creates an item in the data store and inserts data in the item and associates the item with an identifier; a delete item procedure that deletes an item from the data store; and a get item procedure that retrieves data from the data store;
process the request; and
return data to the client that relates only to the item requested by the client.

18. The system of claim 17, wherein the API further comprises a get item without lock procedure that retrieves data from an item in the data store without placing a virtual lock on the data, and a get item with lock procedure that retrieves data from an item in the data store and attempts to place a virtual lock on the data for exclusive access by the requesting client.

19. The system of claim 18, wherein the API further comprises functionality for indicating a timeout that indicates an expiration time of an item of the data in the data store.

20. The system of claim 18, wherein the API further comprises a release item lock that removes a virtual lock from an item of data, a delete expired items procedure that deletes all expired items of data from the data store and a refresh item expiration that updates an expiration time of an item of the data in the data store.
